(19) United States
(12) Patent Application Publication
(10) Pub. No.: US 2026/0024744 A1
(43) Pub. Date: Jan. 22, 2026

(54) METHOD OF PRODUCING ELECTRODE ACTIVE MATERIAL SLURRY

(71) Applicant: TOYOTA JIDOSHA KABUSHIKI KAISHA, Toyota-shi (JP)

(72) Inventors: Hirokazu TAKEUCHI, Toyota-shi (JP); Shinji KOJIMA, Nagoya-shi (JP); Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 19/074,763

(22) Filed: Mar. 10, 2025

(30) Foreign Application Priority Data
Jul. 19, 2024 (JP) 2024-115975

(51) Int. Cl. H01M 4/04; H01M 4/02

(52) U.S. Cl. CPC H01M 4/0471; H01M 2004/028

(57) ABSTRACT

The method of the present disclosure for producing an electrode active material slurry includes kneading a raw material mixture in a kneading device, wherein the kneading device has a heating portion for heating the lowermost portion of the raw material mixture and a cooling portion for cooling the uppermost portion of the raw material mixture, and during the kneading, the temperature of the heating portion is 5° C. or higher than the temperature of the cooling portion.

### CROSS-REFERENCE TO RELATED APPLICATION

This application claims priority to Japanese Patent Application No. 2024-115975 filed on Jul. 19, 2024. The disclosure of the above-identified application, including the specification, drawings, and claims, is incorporated by reference herein in its entirety.

### BACKGROUND

### 1. Technical Field

The present disclosure relates to a method of producing electrode active material slurry.

### 2. Description of Related Art

In recent years, lithium ion secondary batteries have been widely used in a variety of applications, such as being mounted on a hybrid electric vehicle, for example. Therefore, there is an increasing need for improving the performance of the lithium ion secondary batteries, and the importance of the technology for improving the performance of the lithium ion secondary batteries is increasing.

In a manufacturing process of a lithium ion secondary battery, a negative electrode active material layer and a positive electrode active material layer are generally formed using electrode active material slurry (or paste) for a negative electrode and electrode active material slurry (or paste) for a positive electrode, respectively. Since the quality of each slurry is directly related to the performance of the lithium ion secondary battery, the quality control of the slurry in the manufacturing process of the lithium ion secondary battery is a very important factor.

For example, Japanese Unexamined Patent Application Publication No. 2010-257653 (JP 2010-257653 A) discloses a method of producing paste, the method including a powder mixing step, a first dispersion medium addition step, a kneading step, and a second dispersion medium generation step. In the powder mixing step, powder to be a raw material of the paste is mixed to generate a powder mixture. In the first dispersion medium addition step, a dispersion medium is added to the powder mixture to generate a raw material. In the kneading step, the raw material is kneaded in order to promote dispersion of the powder mixture in the raw material. In the second dispersion medium generation step, a dispersion medium is further added to the raw material that has been subjected to the kneading step.

A correlation between the amount of the dispersion medium to be added in the first dispersion medium addition step when the kneading time for performing the kneading step is constant and the viscosity, particle size, and peel strength of the paste is obtained. An optimum amount of the dispersion medium to be added in the first dispersion medium addition step is determined based on the obtained correlation. According to the method described in JP 2010-257653 A, the manufacturing conditions in the kneading process are controlled, the quality control of the paste is enabled, and the supply of paste of a stable quality is enabled, which contributes to the stability of the quality of the lithium secondary battery.

Japanese Unexamined Patent Application Publication No. 2013-093140 (JP 2013-093140 A) discloses a method of producing slurry for a battery electrode, in which at least various constituent materials such as an electrode active material and a binder are put into a stirring tank of a stirring device to produce slurry for a battery electrode. The stirring device includes a bottom wall-side blade, a dispersion blade, and a swirl flow generation blade. The stirring device is a blade that rotates on the most bottom wall side of the stirring tank, and acts to push out the materials put into the stirring tank toward the inner peripheral wall side. The dispersion blade is provided above the bottom wall-side blade, and improves the dispersibility of the input materials by rotating a resistance member formed in the up-down direction around the rotation center. The swirl flow generation blade is provided above the dispersion blade, and generates a swirl flow in a central region of the stirring tank. According to the method described in JP 2013-093140 A, slurry having good coatability and dispersibility and suitable for use in a battery electrode can be produced in a short time.

Japanese Unexamined Patent Application Publication No. 2017-188397 (JP 2017-188397 A) discloses a kneading method of producing battery electrode slurry, in which materials for producing battery electrode slurry containing a binder are urged, transported, and kneaded to produce battery electrode slurry. The kneading method of producing battery electrode slurry includes a first step, a second step, a third step, and a fourth step. In the first step, a plurality of materials for producing the battery electrode slurry is supplied, and the supplied materials are kneaded to be continuously discharged. In the second step, the materials discharged in the first step are transported. In the third step, the temperature of at least one of the materials being kneaded in the first step and the materials being transported in the second step is measured. In the fourth step, the temperature of at least one of the materials supplied to be kneaded in the first step, the materials being kneaded in the first step, and the materials being transported in the second step is controlled so as to be lower than the curing temperature of the binder based on the result of the measurement in the third step. According to the method described in JP 2017-188397 A, the quality of the battery electrode slurry can be maintained stably.

Japanese Unexamined Patent Application Publication No. 2010-182485 (JP 2010-182485 A) discloses a method of producing electrode slurry containing a solvent, active material particles, and a resin dissolved in the solvent. The method of producing electrode slurry includes a stirring step of obtaining dispersed slurry in which the active material particles and the resin are dispersed by stirring, and a flow storage step of causing the stirred dispersed slurry to flow to a storage portion and storing the dispersed slurry in the storage portion. The stirring step and the flow storage step are performed, at any location where the dispersed slurry is to be present, with the slurry temperature of the dispersed slurry at the location and the member temperature of a member in contact with the dispersed slurry being higher than the dew point temperature of the atmosphere in contact with the dispersed slurry at the location. According to the method described in JP 2010-182485 A, it is possible to suppress the deterioration of the characteristics due to the mixing of moisture during the period from kneading to storage.

Japanese Unexamined Patent Application Publication No. 2018-060703 (JP 2018-060703 A) discloses a viscosity measurement device for electrode slurry. The viscosity measurement device includes: a slurry presence chamber in which electrode slurry in which electrode powder and a solvent are mixed is present; a slurry introduction port for introducing the electrode slurry into the slurry presence chamber; a slurry discharge port for discharging the electrode slurry from the slurry presence chamber; a vibrating viscometer disposed in the slurry presence chamber; and a slurry flow generator that provides a constant slurry flow to the vibrating viscometer. According to the device described in JP 2018-060703 A, it is possible to measure the viscosity of the electrode slurry for quality control in continuous production in situ (at the spot).

### SUMMARY

In the production of the electrode active material slurry, mechanical kneading is generally used, and a raw material mixture is kneaded by a kneading device. In this case, when the electrode active material slurry is kneaded, the raw material mixture may not be sufficiently dispersed, and aggregation may occur. When aggregation of the raw material mixture occurs, the homogeneity and the quality of the electrode active material slurry may be reduced.

Therefore, an object of the present disclosure is to improve the dispersibility of a raw material mixture by the heat convection generated during kneading of the raw material mixture, and accordingly to improve the quality of electrode active material slurry.

The present disclosure achieves the above object by the following measures.

### First Aspect

A method of producing electrode active material slurry, the method including kneading a raw material mixture in a kneading device, in which: the kneading device includes a heating unit that heats a lowermost portion of the raw material mixture, and a cooling unit that cools an uppermost portion of the raw material mixture. During the kneading, a temperature of the heating unit is 5° C. or more higher than a temperature of the cooling unit.

### Second Aspect

The method according to the first aspect, in which during the kneading, a temperature of the lowermost portion of the raw material mixture is 5° C. or more higher than a temperature of the uppermost portion of the raw material mixture.

### Third Aspect

The method according to the first or second aspect, in which the raw material mixture has a viscosity of 90,000 mPa·s or more.

### Fourth Aspect

A method of manufacturing a secondary battery, the method including: producing electrode active material slurry by the method according to any one of the first to third aspects; and applying and drying the electrode active material slurry to form an electrode active material layer.

According to the method of the present disclosure, it is possible to improve the dispersibility of a raw material mixture by the heat convection generated during kneading of the raw material mixture, and accordingly to improve the quality of electrode active material slurry.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a kneading device that can be used in the method of the present disclosure.

### DETAILED DESCRIPTION OF EMBODIMENTS

### Method for Producing Electrode Active Material Slurry

The method of the present disclosure for producing an electrode active material slurry comprises:
Including kneading the raw material mixture in a kneading device.
The kneading device includes a heating unit that heats the lowermost portion of the raw material mixture and a cooling unit that cools the uppermost portion of the raw material mixture.
During kneading, the temperature of the heating portion is 5° C. or higher than the temperature of the cooling portion.

According to the method of the present disclosure for producing an electrode active material slurry, it is possible to achieve an improvement in dispersibility of a raw material mixture and an accompanying improvement in quality of the electrode active material slurry.

Also in the conventional manufacturing method, the raw material mixture is kneaded in a kneading device. However, in this case, the dispersion of the material is not sufficient, and agglomeration of the raw material mixture may occur. When the aggregation of the raw material mixture occurs in this way, the homogeneity and the quality of the electrode active material slurry become low.

On the other hand, according to the method of the present disclosure, the kneading device includes a heating unit that heats the lowermost portion of the raw material mixture, and a cooling unit that cools the uppermost portion of the raw material mixture, and kneading is performed in a state where the temperature of the heating unit of the kneading device is 5° C. or higher than the temperature of the cooling unit of the kneading device. This makes it possible to generate a thermal convection, in particular a Benard convection, of the raw material mixture during the kneading of the raw material mixture. According to the thermal convection, it is possible to improve the dispersibility of the raw material mixture and the quality of the electrode active material slurry.

Specifically, during kneading, the temperature of the heating unit may be 5° C. or more, 10° C. or more, 20° C. or more, 30° C. or more, 40° C. or more, 50° C. or more, or 60° C. or more higher than the temperature of the cooling unit. The temperature difference may be 100° C. or less, 90° C. or less, 80° C. or less, or 70° C. or less.

The temperature of the heating unit may be 60° C. or higher, 65° C. or higher, or 70° C. or higher, and may be 90° C. or lower, 85° C. or lower, or 80° C. or lower. The temperature of the cooling unit may be 0° C. or higher, 5° C. or higher, or 10° C. or higher, and may be 30° C. or lower, 25° C. or lower, or 20° C. or lower. In particular, when the temperature of the heating portion and the temperature of the cooling portion are both 5° C. or more and 80° C. or less, it is possible to suppress the slurry from being extremely deteriorated.

Hereinafter, embodiments of the present disclosure will be described in detail. Note that the present disclosure is not limited to the following embodiments, and various modifications can be made within the scope of the gist of the present disclosure.

The method for producing an electrode active material slurry according to the present disclosure includes kneading a raw material mixture in a kneading device.

In the methods of the present disclosure, the kneading can be performed using a mixing agitator, ball mill, sand mill, bead mill, disperser, ultrasonic disperser, homogenizer, homomixer, planetary mixer, planetary agitation defoaming device, etc. as a kneading device. The mixing speed in the kneading device can be freely set within a range of a speed at which each component of the electrode active material slurry can be sufficiently dispersed or dissolved.

The kneading device includes a heating unit that heats the lowermost portion of the raw material mixture, and a cooling unit that cools the uppermost portion of the raw material mixture.

Specifically, the heating unit may be an electric heater, a heat exchanger having a heating fluid flow path, or the like. The cooling unit may be a heat exchanger or the like having a cooling fluid flow path. Further, the heating part and the cooling part may be in direct contact with the lowermost part and the uppermost part of the raw material mixture, respectively. The bottom and top of the feed mixture may be contacted via a thermally conductive medium, such as a metal. Alternatively, a space may be provided between the bottom and the top of the raw material mixture.

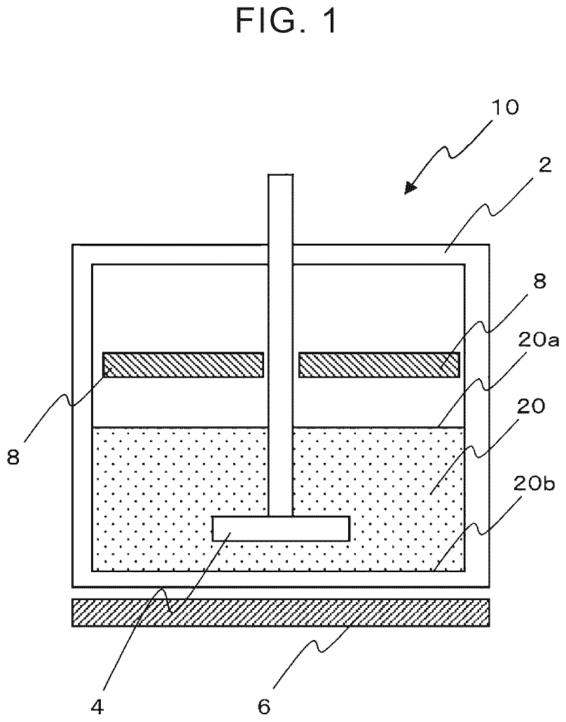

For example, as shown in FIG. 1, the kneading device 10 used in the disclosed process includes a kneading vessel 2 in which the raw material mixture 20 is contained, a stirrer 4, a heating unit 6 for heating the lowermost 20b of the raw material mixture 20, and a cooling unit 8 for cooling the uppermost 20a of the raw material mixture 20.

### Electrode Active Material Slurry

The electrode active material slurry is produced by kneading a raw material mixture in a kneading device. The raw material mixture may include an electrode active material powder and a dispersion medium.

The viscosity of the raw material mix may be at a shear rate 0.1 s⁻¹, greater than or equal to 80,000 mPa s, greater than or equal to 90,000 mPa s, or greater than or equal to 100,000 mPa s. The viscosity of the raw material mixture may be less than or equal to the shear rate 150,000 mPa·s, less than or equal to 140,000 m·Pas, or less than or equal to 130,000 mPa·s. In particular, when the viscosity of the raw material mixture is 90,000 mPa·s or more, it is preferable to generate Benard convection in the raw material mixture in order to improve the homogeneity of the obtained electrode active material slurry. That is, the electrode active material slurry produced by the method of the present disclosure has a relatively high viscosity, and therefore may be in a state generally referred to as a paste.

The viscosity of the raw material mixtures can be measured, for example, using a viscosity measuring instrument at a temperature of 25° C. under the condition of a shear rate 0.1 s⁻¹. As the viscometer, a Kinexus series-rotating rheometer (NETZSCH) or the like can be used. When the viscosity of the raw material mixture changes during the kneading, the raw material mixture may have the viscosity described above during at least a part of the period during the kneading.

The electrode active material powder may be a positive electrode active material powder or a negative electrode active material powder. The raw material mixture may further contain a conductive aid, a binder, and the like. When a positive electrode active material slurry is produced as the electrode active material slurry, the raw material mixture may contain, in addition to the dispersion medium, a positive electrode active material powder, a binder, and, if necessary, a conductive aid. When a negative electrode active material slurry is produced as the electrode active material slurry, the raw material mixture may contain, in addition to the dispersion medium, a negative electrode active material powder, a binder, and, if necessary, a conductive aid. The active material powder may be 70 parts by mass or more, 80 parts by mass or more, or 90 parts by mass or more, and may be 96 parts by mass or less, 98 parts by mass or less, or 100 parts by mass or less of the raw material mixture.

### Positive Electrode Active Material

The material of the positive electrode active material is not particularly limited. The positive electrode active material may be, for example, lithium cobaltate (LiCoO₂), lithium nickelate (LiNiO₂), lithium manganate (LiMn₂O₄), lithium nickel cobalt manganate (NCM:LiCO_{1/3}Ni_{1/3}Mn_{1/3}O₂), lithium nickel cobalt aluminum oxide (LiNi_{0.8}(CoAl)_{0.2}O₂), or a heterogeneous element-substituted Li—Mn spinel. The composition of the heterogeneous element-substituted Li—Mn spinel is represented as Li₁₊ₓMn_{2-x-y}M_{y}O₄ (M is one or more metallic elements selected from Al, Mg, Co, Fe, Ni, and Zn). The material of the positive electrode active material is not limited thereto.

The shape of the positive electrode active material is not particularly limited. The positive electrode active material may be a primary particle or a secondary particle in which a plurality of primary particles is aggregated. The mean particle diameter D₅₀ of the positive electrode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

### Negative Active Material

The material of the negative electrode active material is not particularly limited, and may be metal lithium, or may be a material capable of occluding and releasing metal ions such as lithium ions. Examples of the material capable of occluding and releasing metal ions such as lithium ions include, but are not limited to, an alloy-based negative electrode active material, a carbon material, and lithium titanate (Li₄Ti₅O₁₂).

The alloy-based negative electrode active material is not particularly limited, and examples thereof include a Si alloy-based negative electrode active material and a Sn alloy-based negative electrode active material. Examples of the Si alloy-based negative electrode active material include silicon, silicon oxide, silicon carbide, silicon nitride, and solid solutions thereof. The Si alloy-based negative electrode active material may include metallic elements other than silicon, for example, Fe, Co, Sb, Bi, Pb, Ni, Cu, Zn, Ge, In, Sn, Ti or the like. Examples of the Sn alloy-based negative electrode active material include tin, tin oxide, tin nitride, and solid solutions thereof. The Sn alloy-based negative electrode active material may include metallic elements other than tin, for example, Fe, Co, Sb, Bi, Pb, Ni, Cu, Zn, Ge, In, Ti, Si or the like.

The carbon material is not particularly limited, and examples thereof include hard carbon, soft carbon, and graphite.

The shape of the negative electrode active material is not particularly limited. The negative electrode active material may be a primary particle or a secondary particle in which a plurality of primary particles is aggregated. The mean particle diameter D₅₀ of the negative electrode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. The mean particle diameter D₅₀ is the particle diameter (median diameter) at an integrated value of 50% in the volume-based particle size distribution determined by the laser diffraction/scattering method.

### Conductive Aid

As the conductive aid, carbon powder such as acetylene black, furnace black, or carbon black can be used. In addition, a mixture of a plurality of types of these may be used. The conductive auxiliary may be 0.001 parts by mass or more, 0.003 parts by mass or more, or 0.005 parts by mass or more, and may be 0.3 parts by mass or less, 0.2 parts by mass or less, or 0.1 parts by mass or less of the raw material mixture.

### Binder

As the binder, an organic solvent-based (non-aqueous) binder such as polyvinylidene fluoride (PVdF) or polytetrafluoroethylene (PTFE) used by being dissolved in an organic solvent can be used. It is also possible to use, as a water-based binder, water-dispersible styrene-butadiene rubber (SBR), methyl (meth)acrylate, ethyl (meth)acrylate, butyl (meth)acrylate, (meth)acrylonitrile, ethylenically unsaturated carboxylic acid ester, ethylenically unsaturated carboxylic acid, water-based polymers, alginic acid compounds, and the like. Examples of the ethylenically unsaturated carboxylic acid ester include hydroxyethyl (meth)acrylate. Examples of the ethylenically unsaturated carboxylic acid include acrylic acid, methacrylic acid, itaconic acid, fumaric acid, and maleic acid. The water-based polymer is, for example, carboxymethylcellulose (CMC), which is used not only in combination with SBR but also attracts attention as a binder in recent years. In addition, a mixture of a plurality of types of these may be used. The binder may be 0.01 parts by mass or more, 0.05 parts by mass or more, or 0.1 parts by mass or more, and may be 9 parts by mass or less, 7 parts by mass or less, or 5 parts by mass or less of the raw material mixture.

The binder may be dissolved or dispersed in a solvent. As the solvent, N-methyl-2-pyrrolidone, dimethylformamide, isopropanol, toluene, water, and the like can be used, and a mixture of a plurality of these can also be used. These may be appropriately selected and used in accordance with the type and characteristics of the thickener or active material to be used.

### Dispersion Medium

Specific examples of the dispersion medium include N-methyl-2-pyrrolidone (hereinafter occasionally abbreviated as “NMP”), dimethylformamide, dimethylacetamide, methanol, acetone, methyl ethyl ketone, methyl isobutyl ketone, cyclohexanone, methyl acetate, ethyl acetate, tetrahydrofuran, and water. One kind of the dispersion medium may be used alone, or two or more kinds may be used in combination. From the viewpoint of versatility, removability, and the like, the dispersion medium is preferably NMP or water. The dispersion medium may be 0.01 parts by mass or more, 0.05 parts by mass or more, or 0.1 parts by mass or more, and may be 9 parts by mass or less, 7 parts by mass or less, or 5 parts by mass or less of the raw material mixture.

### Method for Manufacturing Secondary Battery

A method of the present disclosure for manufacturing a secondary battery includes:
Manufacturing an electrode active material slurry in the method of the present disclosure, and
Coating and drying the electrode active material slurry to form an electrode active material layer, Include.

The electrode active material slurry can be applied to a current collector, dried, or applied to a transfer substrate, dried, and then transferred to a current collector, and the like.

The present disclosure will be described in more detail with reference to the following examples, but the scope of the present disclosure is not limited by these examples.

Hereinafter, an electrode active material slurry was manufactured according to the manufacturing method according to the embodiment.

### Comparative Example 1

A raw material mixture containing the following materials was prepared:
Active material: artificial graphite (D₅₀=20 μm), 95 parts by weight
Dispersion medium: carboxymethylcellulose (CMC), 1 part by weight
Conductive aid: carbon nanotube (CNT), 0.1 parts by weight
Binder: styrene-butadiene rubber (SBR), 3.9 parts by weight

A planetary mixer was used as a kneading device. The kneading device includes a cooling unit at an upper portion of the kneading device, and a heating unit at a lower portion of the kneading device. The raw material mixture was supplied to a kneading device and kneaded under the following conditions to obtain an electrode active material slurry of Comparative Example 1. The temperature of the uppermost portion of the raw material mixture was substantially the same as the temperature of the cooling portion of the upper portion of the kneading device, and the temperature of the lowermost portion of the raw material mixture was substantially the same as the temperature of the heating portion of the lower portion of the kneading device.

Temperature of the cooling section (top of the raw material mixture) at the top of the kneading device: 25° C.
Temperature of the heating part (lowermost part of the raw material mixture) at the lower part of the kneading device: 25° C.
Temperature difference: 0° C.

### Comparative Examples 2 and Examples 1 to 6

The electrode active material slurries of Comparative Example 2 and Examples 1 to 6 were obtained in the same manner as in Comparative Example 1, except that the temperature of the cooling portion (the uppermost portion of the raw material mixture) at the upper portion of the kneading device and the temperature of the heating portion (the lowermost portion of the raw material mixture) at the lower portion of the kneading device were changed as shown in Table 1 below.

### Evaluation

The viscosity of the electrode active material slurries of Comparative Examples 1 and 2 and Examples 1 to 6 was measured using a rheometer, and the viscosity was 120,000 mPa s at a shear rate 0.1 s⁻¹. For the electrode active material slurries of Comparative Examples 1 and 2 and Examples 1 to 6, the presence or absence of aggregation was evaluated using a grind gauge (particle size gauge). Specifically, skied on a grid gauge for each of the electrode active material slurry, for the electrode active material slurry that there was no squeeze up to 200 μm, it was determined that there is no coherence. The electrode active material slurry in which streaking occurred up to 200 μm or more, it was determined that there was aggregation. The evaluation results are shown in Table 1 below.

TABLE 1

| | Temperature | Temperature | | | |
|---|---|---|---|---|---|
| | of the cooler | of the cooler | | | |
| | at the top of | at the lower | | | |
| | the kneading | part of the | Temperature | | Aggrega- |
| | device | kneading device | difference | | tion |
| Comparative | 25° C. | 25° C. | 0° | C. | Found |
| Example 1 | | | | | |
| Comparative | 23° C. | 25° C. | 2° | C. | Found |
| Example 2 | | | | | |
| Example 1 | 20° C. | 25° C. | 5° | C. | None |
| Example 2 | 10° C. | 25° C. | 15° | C. | None |
| Example 3 | 25° C. | 30° C. | 5° | C. | None |
| Example 4 | 10° C. | 30° C. | 20° | C. | None |
| Example 5 | 10° C. | 50° C. | 40° | C. | None |
| Example 6 | 20° C. | 80° C. | 60° | C. | None |

From Table 1, agglomeration was observed in the electrode active material slurries of Comparative Examples 1 and 2 in which the difference between the temperature of the cooling portion (the top portion of the raw material mixture) and the temperature of the heating portion (the bottom portion of the raw material mixture) was less than 5° C. On the other hand, no aggregation was observed in the electrode active material slurries of Examples 1 to 6 in which the difference between the temperature of the cooling portion (the uppermost portion of the raw material mixture) and the temperature of the heating portion (the lowermost portion of the raw material mixture) was 5° C. or more.

What is claimed is:

1. A method of producing electrode active material slurry, the method comprising kneading a raw material mixture in a kneading device, wherein:
the kneading device includes a heating unit that heats a lowermost portion of the raw material mixture, and a cooling unit that cools an uppermost portion of the raw material mixture; and
during the kneading, a temperature of the heating unit is 5° C. or more higher than a temperature of the cooling unit.

2. The method according to claim 1, wherein during the kneading, a temperature of the lowermost portion of the raw material mixture is 5° C. or more higher than a temperature of the uppermost portion of the raw material mixture.

3. The method according to claim 1, wherein the raw material mixture has a viscosity of 90,000 mPa·s or more.

4. A method of manufacturing a secondary battery, the method comprising:
producing electrode active material slurry by the method according to claim 1; and
applying and drying the electrode active material slurry to form an electrode active material layer.
